(19) United States
(12) Patent Application Publication
(10) Pub. No.: US 2013/0063241 A1
(43) Pub. Date: Mar. 14, 2013

(54) SECURE MONITORING DEVICE, SYSTEM, AND METHOD

(71) Applicant: Mihai Simon, Aurora, CO (US)

(72) Inventor: Mihai Simon, Aurora, CO (US)

(21) Appl. No.: 13/602,175

(22) Filed: Sep. 2, 2012

Related U.S. Application Data
(60) Provisional application No. 61/533,201, filed on Sep. 10, 2011.

(51) Int. Cl. G05B 23/00; G06F 13/42

(52) U.S. Cl. 340/3.1; 340/1.1

(57) ABSTRACT

A secure monitoring device, system, and method to aid response and investigation of events. An example secure monitoring device includes a fire and tamper resistant enclosure. A processing device is provided in the fire and tamper resistant enclosure to analyze an event for an anomaly and a black-box mode to secure all system events for the secure monitoring device when the anomaly is a threat to the secure monitoring device. The secure monitoring device, system, and method may include preprogramming and packaging as an integrated building security and building automation device.

### PRIORITY CLAIM

This application claims priority to U.S. Provisional Patent Application No. 61/533,201 filed Sep. 10, 2011 and titled “Integrated security and automation system with access control” of Mihai Simon, which is hereby incorporated by reference in its entirety as though fully set forth herein.

### BACKGROUND

Security systems may monitor a breach, such as a door or window opening or being broken. Automation systems perform various functions automatically, such as adjusting a thermostat or lights based on time of day, and motors that operate to open and close window coverings.

### BRIEF DESCRIPTION OF THE DRAWINGS

FIGS. 1a-b are perspective views of an example secure monitoring device, wherein (a) shows an access door in a closed position and (b) shows the access door in an open position.

FIG. 2 is a high-level illustration of an example system.

FIG. 3 shows an example architecture of machine readable instructions.

FIG. 4 is a flowchart illustrating example operations.

### DETAILED DESCRIPTION

Secure monitoring device, system, and method are disclosed. In an example, the secure monitoring device may include integrated building security and building automation functions as a preprogrammed and packaged system. In an example, the secure monitoring device may be operable with a security devices such as a burglar alarm (including closed circuit television (CCTV)), and building automation devices (e.g., lighting and temperature control). The secure monitoring device may be configured with hardware components, including a universal power supply (UPS) and battery backup for continuous access and monitoring. The hardware components may be located in a tamper resistant and fire resistant enclosure. The integrated system may also include communications via a local control panel and/or remote means (e.g., a networked computer or mobile device). Access control may be monitored using video and video analytics.

The secure monitoring device may record events on a local fire and water resistant storage device. The recording device may be configured to identify or assist in identifying involvement in an event, thereby reducing investigation time and resources following an event such as an intrusion or fire. The secure monitoring device may also include a notification component configured to notify a remote administrator with information and video (e.g., identifying a person in the building and/or accessing the device).

In an example, the secure monitoring device may further utilize pattern recognition for analyzing an event. For purposes of illustration, the example secure monitoring device may be used as follows. When an employee enters a building through the main entrance by unlocking the door, the event is considered normal and the secure monitoring device automatically disarms the burglar alarm, records a video clip of the person entering the front door, and ma also turn on lights and set the thermostat. The business owner is notified (e.g., via an email) with information about the building entry, and a short video clip may be attached so that the business owner can confirm entry by an authorized employee. But if an intruder enters the building (e.g., from a window or back entry), a pattern violation is detected and the event is considered an anomaly. The secure monitoring device may activate the alarm system and notify the authorities. The business owner may also be notified (e.g., via an email) with information about the building entry, and a short video clip may be attached so that the business owner can monitor the situation.

All events may be recorded on a local fire and water proof hard drive. If the building burns down, the business owner still has video, audio, historical access records, and an intrusion log. The records may also be used to identify or assist in identifying who was involved in the fire or what may have gone wrong. Accordingly, the system may reduce investigation time and resources (e.g., police and fire department personnel).

By way of further example, a building security, life safety and automation system to aid in response and investigation of events may include a fire and tamper resistant enclosure; a processing device(s) in the enclosure, the processing device(s) to monitor building status and perform various security and energy functions, of burglar alarms, access control systems, closed circuit television systems and building automation systems, analyzing events for anomalies and performing various predetermined tasks based on macro programming; a fire, water and/or shock-proof recording means, located in the enclosure, whereas all system events, such as alarm logs, access logs, video footage and other system related data is securely stored; and a backup power source physically located within the enclosure.

In another example, a building security, life safety and automation system to aid in response and investigation of events may include a secure enclosure; a processing device(s) in the enclosure, the processing device(s) to monitor building status and perform various security and energy functions, of burglar alarms, access control systems, closed circuit television systems and building automation systems, analyzing events for anomalies and performing various predetermined tasks based on macro programming; a fire, water and shock-proof recording means, located physically within the enclosure, whereas all system events, such as alarm logs, access logs, video footage and other system related data is securely stored; and a backup power source located in the enclosure.

In another example, an intrusion, access, security camera, life safety and automation control system, prepackaged and preprogrammed to integrate with various building sensors and input devices, including a secure, hinged, locked enclosure; multiple processing devices in the enclosure, the processing devices to monitor building status and perform various security and energy functions, typical of burglar alarms, access control systems, closed circuit television systems and building automation systems, analyzing events for anomalies and performing various predetermined tasks based on macro programming; and a fire, and water-proof recording means, located physically within the enclosure, whereas all system events, such as alarm logs, access logs, video footage and other system related data is securely stored; and a backup power source located in the enclosure.

Before continuing, it is noted that as used herein, the terms “includes” and “including” mean, but is not limited to, “includes” or “including” and “includes at least” or “including at least”. The term “based on” means “based on” and “based at least in part on.”

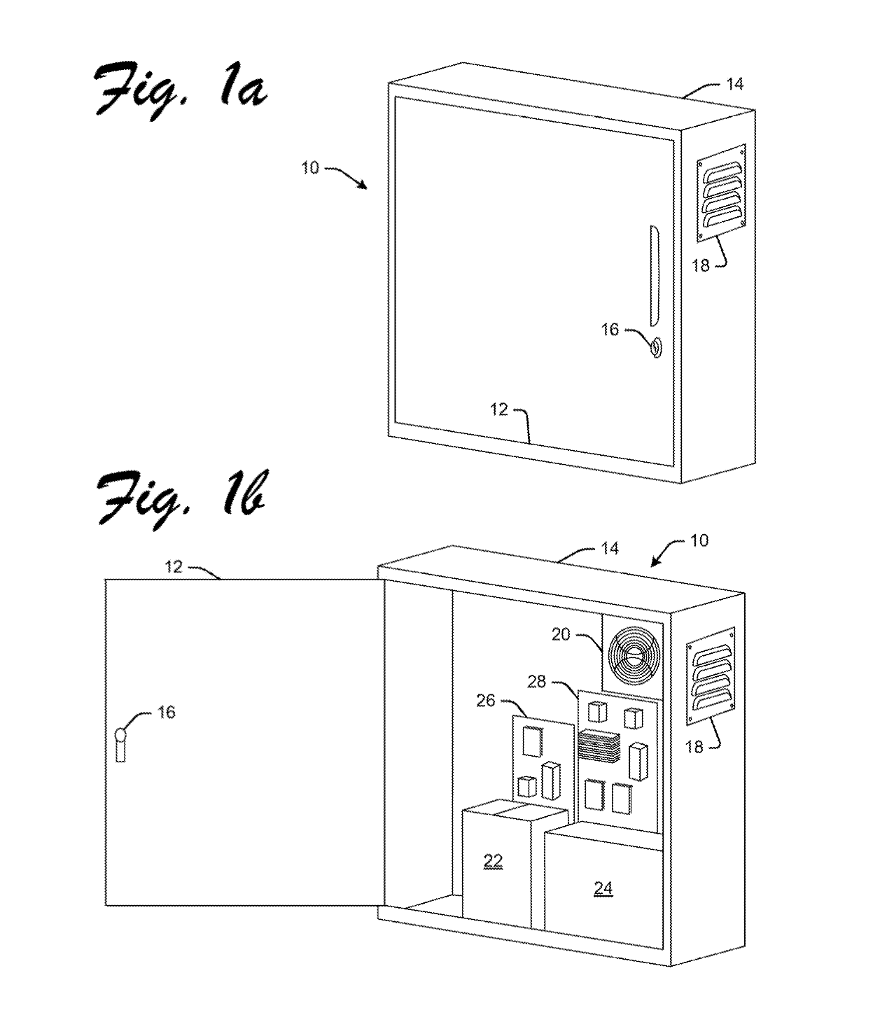

FIGS. 1a-b are perspective views of an example secure monitoring device 10, wherein (a) shows an access door 12 in a closed position and (b) shows the access door 12 in an open position. The secure monitoring device 10 may be used to aid response and investigation of events. In an example, the secure monitoring device 10 includes a fire and tamper resistant enclosure 14. The enclosure 14 may be manufactured of a fire and tamper resistant material, and may also include a lock 16. Ventilation openings 18 may be provided so that a cooling device such as fan 20 can exhaust heated air to the surrounding environment.

In an example, the secure monitoring device 10 includes integrated security (or “burglar”) alarm system 22 and building automation system 24. A processing device is provided in the fire and tamper resistant enclosure 14 (e.g., illustrated on a computer board 26). Other computer boards 28 and electronic devices may also be provided, such as battery backup or UPS systems and communications systems. For example, the client may have full access via a network or other communications system (e.g., the Internet via computer or mobile devices).

The secure monitoring device 10 may be implemented with an access control system, such as a security access control that grants and denies access for secure monitoring device 10 only to authorized users (e.g., managers, employees, vendors, etc.). The access control system may be distributed in a pre-programmed mode, e.g., with a set of key-fobs, so that no installer programming is needed. Although it is noted that the access control system is programmable if circumstances call for it or users specifically request certain functions. Otherwise, features may be pre-programmed using a pre-order checklist for the customer to fill in. In an example, if the door is open too long, the door is forced open, and other alarms are also available to be integrated in macro commands.

The secure monitoring device 10 may also use bi-directional commands and statuses provided to and from security system devices. The secure monitoring device 10 may be configured to use the communication signals in a macro format (giving the manufacturer the ability to manipulate the system via macros). Additional features may be hard-coded as desired.

The security system may include hardwired and wireless components. The security system may be used as a burglar alarm, e.g., by calling a monitoring service upon an intrusion or alarm event. In addition, the security system may be programmed during manufacture so that little or no customization is needed after purchase. User codes may be pre-programmed as per the customer. In an example, programming can be completed at the installer's shop, and not in the field.

An additional relay may be provided for command output to be a dry contact. For example, this may be used to open front or garage doors.

The security system may also include a surveillance system. An example surveillance system supports a CCTV Capture Card, IP encoder and Analytics software. The surveillance system may provide a single or multi-view of cameras. The CCTV system may include a live view, recording and playback. Some example features of the CCTV system include, but are not limited to, live camera view (e.g., a single channel at a time), recording based on motion, schedule and macro programming, and recording on an external hard-drive, recording high quality, short clips. The recorded clip may be attached to an email and delivered (as indicated by macro programming, email to contain link to live video feed).

Other example features of the surveillance system may include, but are not limited to, playback to be provided by a scheduling command and/or by system events (such as door open, motion active, system disarmed, etc. . . . as indicated by macros). Even if the system is recording based on a schedule, the user may also be able to review video based on events. The surveillance system may achieve this without the need to “double-record”. Playback may be remotely via PC and smartphone.

A live view may be available to remote PC and smartphone (accommodating available bandwidth). The surveillance system may also provide PTZ control to IP cameras. PTZ control may be used for analog cameras, e.g., using an IP encoder with rs-485 connections. RS-232 integration may also be provided for cash registers and transaction marking.

The surveillance system may support a live view and playback of multiple cameras at the same time or substantially the same time (e.g., 4, 8, or 16 cameras). Live view may provide recording and playback options. Interface video analytics may be used to generate specific event triggers.

The secure monitoring device 10 may also be implemented with an automation system. Building automation features may be added to any base platform. In an example, these features may be added by the owner on the owner's timetable (e.g., before, during, or after installation).

It is noted that the functions described herein may be implemented with any of a wide variety of computing devices, such as, but not limited to motherboards and/or blade servers, to name only a few examples. The computing devices may include memory, storage, and a degree of data processing capability at least sufficient to manage a communications connection with another entity (e.g., alarm system component or building automation component), either directly or indirectly (e.g., via a network). At least one of the computing devices is also configured with sufficient processing capability to execute the program code described herein.

During operation, an event may be detected by the alarm system (e.g., a door opening, a break-in, a fire, etc.). The processing device (illustrated on computer board 26) may analyze the event for an anomaly. If the event is determined to be an anomaly, the processing device may issue an alert (e.g., to the building owner or administrator or to appropriate response personnel such as the police or fire station). Alerts may be further monitored externally by a monitoring service. If the anomaly is determined to be a threat to the secure monitoring device 10 itself (such as a fire, or if there is evidence of tampering by an intruder), the secure monitoring device 10 may further enter a “black-box” mode, wherein additional measures are taken to preserve data (such as recording video and/or transferring data offsite). In another example, the system may be always-on in the black-box mode (i.e., a trigger is not necessary to enter the black-box mode.

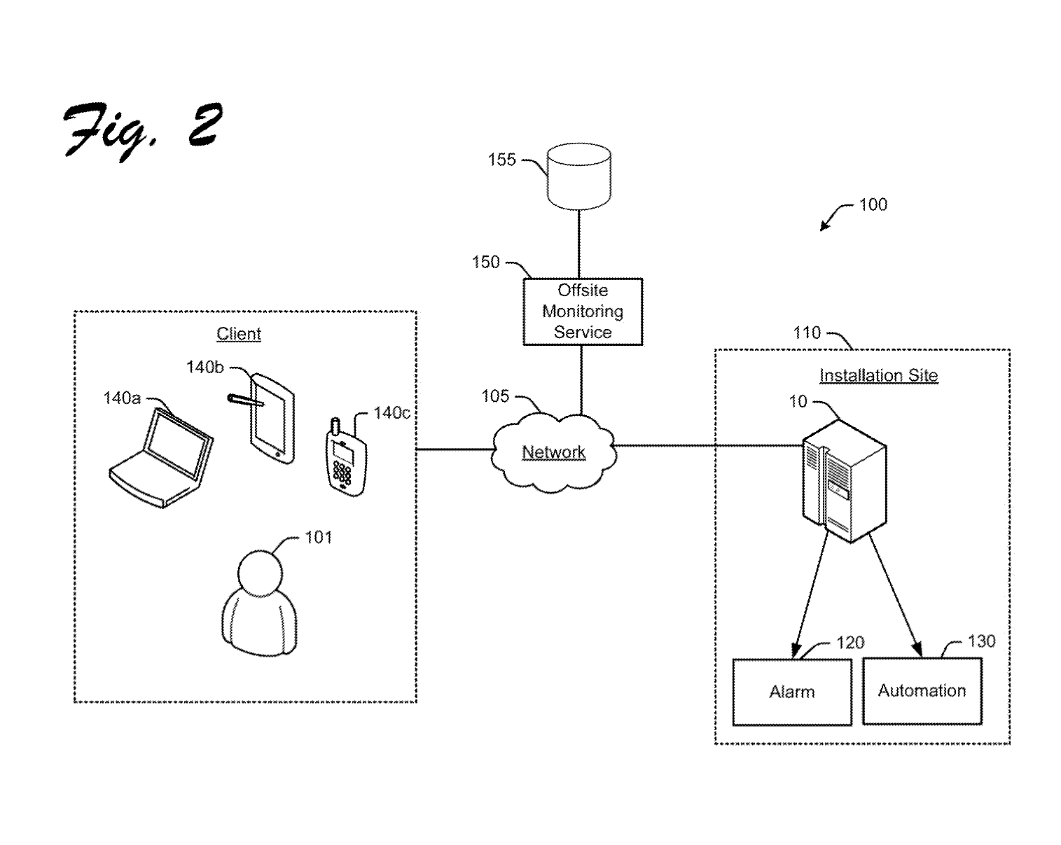

FIG. 2 is a high-level illustration of an example system 100 in which the secure monitoring device 10 may be implemented. In an example, the system 100 includes an installation site 110 (such as a building to be monitored) where the secure monitoring device 10 is installed. For purposes of illustration, the secure monitoring device 10 is shown as it may be implemented with alarm system components 120 and/or building automation system components 130. The secure monitoring device 10 may be communicatively coupled via a network 105 to a client, such as the building owner 101.

The client may interact with the secure monitoring device 10 via any suitable computing device 140a-c capable of accessing the secure monitoring device 10. The client devices are not limited to any particular type of devices. In addition, the client may be located offsite, onsite, and/or may come and go from the installation facility 110. Also as noted above, the secure monitoring device 10 may be connected to a third party or offsite monitoring service 150. The monitoring service 150 may be a cloud-based service provider, such as an alarm monitoring service. Using a third party or offsite monitoring service 150 provides an additional level of security for responding to events at the installation facility 110. The offsite monitoring service 150 may also provide offsite data storage capability, as illustrated by storage device 155. For example, data may be transferred offsite as backup and/or when an anomaly indicates a threat to the secure monitoring device 10 (when the secure monitoring device 10 enters black-box mode).

In an example, functions of the secure monitoring device 10 may be implemented by program code. The program code may be executed to receive video and video analytics to control building access and detect intrusions. A video analytics module may be executed to identify a person involved in the event. The program code may also be integrated with building automation functions. In an example, the program code may actuate at least one building automation function in response to entering the black-box mode. For example, the program code may actuate a sprinkler system in response to detecting a fire, or may secure exits during an intrusion.

In an example, the secure monitoring device 10 may be preprogrammed and packaged as an integrated building security and building automation device. Preprogramming may be based on the type of business where the secure monitoring device 10 is to be installed. For example, stores may be preprogrammed based on the usual needs of store employees (e.g., open/close the business) with video of the cash register. A secure monitoring device 10 for professional services businesses may be preprogrammed based on the usual needs of the professionals working at the business. A secure monitoring device 10 for homes may be preprogrammed based on the usual needs of homeowners. The secure monitoring device 10 may also come prepackaged with security devices (e.g., door monitors, video cameras) and building automation devices (e.g., thermostats, lighting controls) based on the type of installation. Preprogramming and packing the secure monitoring device 10 in such a manner enables easy installation by the end-user and/or installer.

In an example, the secure monitoring device 10 may also be programmed for pattern recognition. For example, a pattern may be programmed into the secure monitoring device 10 to recognize that when an employee enters a building through the main entrance by unlocking the door, the event should be considered normal. In response, the secure monitoring device automatically disarms the burglar alarm, records a video clip of the person entering the front door, and ma also turn on lights and set the thermostat. The business owner is notified (e.g., via an email) with information about the building entry, and a short video clip may be attached so that the business owner can confirm entry by an authorized employee. But if an intruder enters the building (e.g., from a window or back entry), a pattern violation is detected and the event is considered an anomaly. The secure monitoring device may activate the alarm system and notify the authorities. The business owner may also be notified (e.g., via an email) with information about the building entry, and a short video dip may be attached so that the business owner can monitor the situation.

Without intending to be limiting, the secure monitoring device 10 may be executed to provide one or more of the following example functions. A loss of phone line may send email alerts. A loss of Internet connectivity may call dispatch via the burglar alarm system.

The secure monitoring device 10 may also be capable of programming entry patterns, CCTV cameras can be mapped to specific security zones (e.g., for email and events recording purposes). For example, each camera may cover up to 2 or 3 or more zones. A video clip of the associated camera(s) may be programmed to be emailed upon occurrence of specific events (this is to be customized using macro commands or site specific setup). The email may also include links to a live video feed.

The secure monitoring device 10 may also implement remote doorbell capabilities. For example, if someone rings the bell, and the user (e.g., building owner) is called, with video conferencing on the phone, so that the user can allow the person to walk into the shop or office (e.g., to deliver a package), all while the user is watching all events live. Other examples include providing the user the ability to “open front door” or “open garage door” via command output to security, remotely arm/disarm and bypass/un-bypass the alarm system.

The secure monitoring device 10 may also support “polling” security devices to ensure all statuses are up to date, monitor any variations, and determine the current state (without a distinct signal having to be sent). The polling system may further trigger a notification to the user with “possible loss of communication” information.

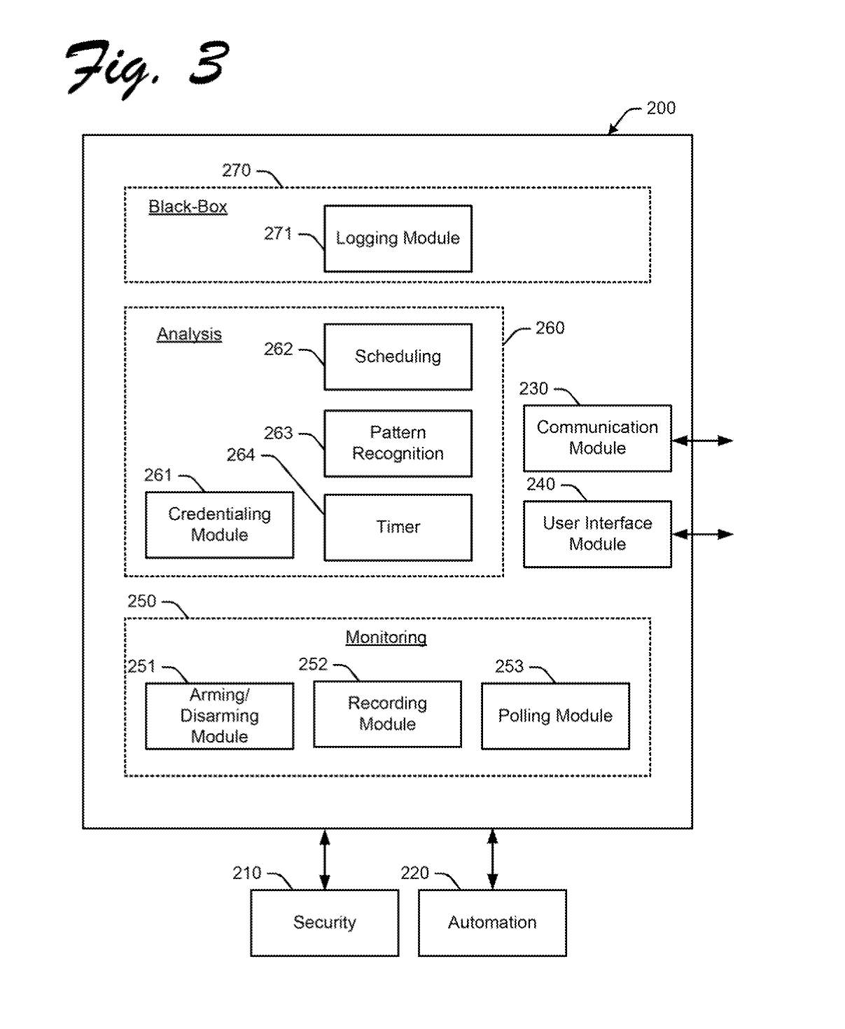

The program code used to implement features of the system can be better understood with reference to FIG. 3 and the following discussion of various example functions. However, the operations described herein are not limited to any specific implementation with any particular type of program code.

FIG. 3 shows an example architecture 200 of machine readable instructions which may be executed by the secure monitoring device 10. In an example, the program code discussed above with reference to FIGS. 1 and 2 may be implemented in machine-readable instructions (such as but not limited to, software or firmware). The machine-readable instructions may be stored on a non-transient computer readable medium and are executable by one or more processor to perform the operations described herein. It is noted, however, that the components shown in FIGS. 1 and 2 are provided only for purposes of illustration of an example operating environment, and are not intended to limit implementation to any particular system.

In an example, the architecture of machine readable instructions may be operatively associated (e.g., via two-way communication) with security system components 210 and/or building automation components 220 to receive input (e.g., an intrusion or fire signal) and/or generate output or commands (e.g., to control a building automation function).

The architecture of machine readable instructions may also be operatively associated with communications devices/network via communications module 230. The communications module 230 may be used to issue alerts and/or receive commands from the building owner or other authorized user.

In an example, secure monitoring device 10 may be configured to automatically send emails and/or MMS (or other remote messages) to clients. The integrated system may also be configured to send attachments (windows media or other open format) of video and other events within email messages (e.g., compressed to fit a narrow bandwidths such as mobile formats).

The architecture of machine readable instructions may also be operatively associated with a user interface via user interface module 240. It is noted that the user interface may be implemented as a keyboard (touchscreen, etc.) on the secure monitoring device 10 itself and/or via remote access such as a computer or mobile device. In an example, the user interface module 240 may also include a web-browser interface for user interaction. The user interfaces may include an N-up display of connected cameras (e.g., 4, 8, 16, etc.) cameras displayed at one time. The integrated system may be secured in software via windows authentication or the like (e.g., windows log-on, LDAP, AD). Anyone accessing the system has to be established as a valid user with proper credentials. In an example, security and access control user names and user codes are entered directly in security. The user number is the common denominator. Multiple partitions may be used to control security and be able to separate different partitions.

The following example is provided for purposes of illustration, and is not intended to be limiting. In this example, an integrated system includes security communication of following 3-digit commands:

000 Heartbeat—every 5 minutes

001 status request—every hour

010 set time and date—daily

020 Command output control—as commanded by macros or user

030 partition arm control—macros or user

040 partition disarm—macros or user

100 bypass zone—macros or user

101 un-bypass zone—macros or user

In an example, commands may be originated, by security and/or access control modules, and are available as inputs in macro commands and logged, with descriptions. A users' list is managed by the installer and system manager. This utilizes a three tier security level scheme. An installer, to have access throughout the integrated system. A system manager, the owner or the designated manager, who has access to user names, scheduling, add or delete users, pan-tilt-zoom (ptz) control, playback recorded footage, access log page, etc. A user (e.g., the lowest level user) is able to only view live video, receive emails, arm, disarm, bypass and command out, and have basic control of the system, but not means of adjusting or making scheduling changes.

The user interface module 240 may also be used for programming (e.g., preprogramming at the factory, during installation, or modifications to the programming by the end user), and may also include programming of patterns indicating which automation functions to actuate in response to pattern recognition. By way of example, a pattern may be programmed to raise the thermostat when the front door is unlocked between 7:45 am and 8:15 am, indicating an employee has entered the building. In another example, a pattern may be programmed to automatically arm the building if the time is after 10 pm and no motion is being detected.

In another example, in the morning, to disarm the burglar alarm, an employee opens door A and triggers motion detector A and B. But if motion detectors A, B, and C go off or any other door before the system is disarmed, then chances are there is an intruder and the system triggers some action(s), such as sounding the bell and turning on lights. In an example, a timer is used to check intrusion system activity. If there is no activity for a specified time (such as 30 minutes or 1 hour) then the integrated system automatically arms the burglar alarm.

The program code described herein may execute the function of the architecture of machine readable instructions as self-contained modules. These modules can be integrated within a self-standing tool, or may be implemented as agents that run on top of an existing program code. The architecture of machine readable instructions may include subsystems such as, but not limited to, a monitoring subsystem 250, analysis subsystem 260, and black-box module 270.

The monitoring subsystem 250 may include module 251 for arming/disarming the security system, module 252 for recording video and/or audio, and module 253 for polling security devices and/or automation devices.

The analysis subsystem 260 may include credentialing module 261 (e.g., for identifying authorized users), scheduling module 262 (e.g., for automatically executing functions such as turning on/off system devices), pattern recognition module 263 (e.g., for identifying pattern violations), and a timer module 264 (e.g., to automatically arm the security system on lack of activity).

The black-box subsystem 270 may include a logging module 271. Logging module 271 may actuate various of the recording devices in the security system (e.g., video and/or audio) which may not otherwise be actuated. Logging module 271 may store the data locally and/or remotely transmit the data for offsite storage. The secure monitoring device 10 may include a user friendly data logging page, where users can easily review all system activity and (links to) associated video clips. AU system events and video information may be stored on a specified drive (e.g., other than the typical “C drive”). Data logging may also be encrypted.

Before continuing, it should be noted that the examples described above are provided for purposes of illustration, and are not intended to be limiting. Other devices and/or device configurations may be utilized to carry out the operations described herein.

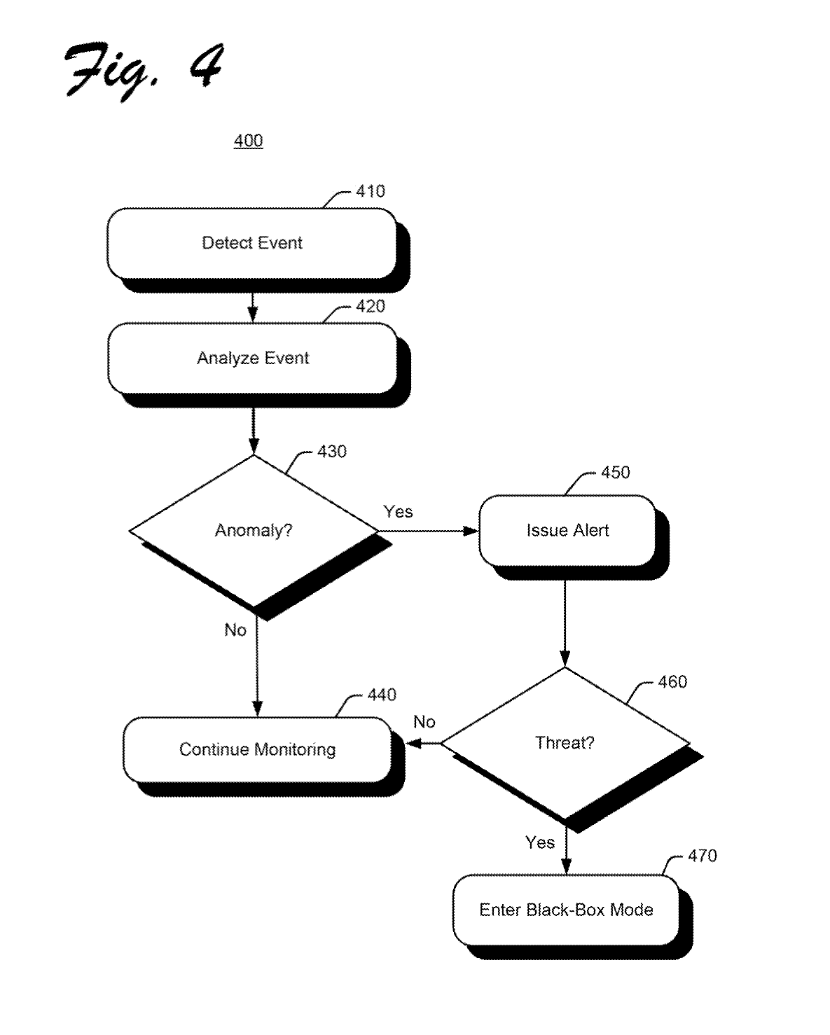

FIG. 4 is a flowchart illustrating example operations of securing a monitoring device to aid response and investigation of events. Operations 400 may be embodied as logic instructions on one or more computer-readable medium. When executed on a processor, the logic instructions cause a general purpose computing device to be programmed as a special-purpose machine that implements the described operations. In an example, the components and connections depicted in the figures may be used.

Operation 410 includes detecting an event at the secure monitoring device. Operation 420 includes analyzing the event, e.g., for an anomaly. A determination is made in operation 430 whether the event is an anomaly. It is noted that not all events are anomalies. For example, when a store employee enters an armed store to open up for the day, this would not be considered an anomaly. If, however, an intruder breaks a window to gain access to the store, this would be considered an anomaly. Of course numerous examples of events (both anomalies and non-anomalies) can be defined for any of a wide range of applications, and the examples given herein are not intended to be limiting.

If the event is not an anomaly, operation 440 continues monitoring. If, however, the event is an anomaly, an alert is issued in operation 450 and a determination is made in operation 460 whether there is a threat to the secure monitoring device itself (e.g., by fire or tampering). Operation 440 may continue monitoring and/or the secure monitoring device 10 may enter black-box mode in operation 470.

In an example, the black-box mode may automatically log information and video of the event (locally and/or remotely). For example, the black-box mode may automatically transfer the information and video of the event to an off-site secure location.

The operations shown and described herein are provided to illustrate example implementations. It is noted that the operations are not limited to the ordering shown. Still other operations may also be implemented.

By way of illustration, further operations may include automatically arming the monitoring device when determining that a building is empty. Operations may include issuing an alert when analyzing the event indicates a pattern violation, the alert notifying a remote administrator with information and video of the event.

The operations may be implemented at least in part using an end-user interface (e.g., web-based interface). In an example, the end-user is able to make predetermined selections, and the operations described above are implemented on a back-end device to present results to a user. The user can then make further selections. It is also noted that various of the operations described herein may be automated or partially automated.

It is noted that the exemplary embodiments shown and described are provided for purposes of illustration and are not intended to be limiting. Still other embodiments are also contemplated.

1. A secure monitoring device to aid response and investigation of events, comprising:
a fire and tamper resistant enclosure;
a processing device in the fire and tamper resistant enclosure, the processing device to analyze an event for an anomaly; and
a black-box to securely store all system events when the anomaly is a threat to the secure monitoring device.

2. The secure monitoring device of claim 1, further comprising video and video analytics to control building access and detect intrusions.

3. The secure monitoring device of claim 1, further comprising at least one building automation function actuated in response to entering the black-box mode.

4. The secure monitoring device of claim 1, further comprising a communication module to notify a remote administrator with information and video of the event.

5. The secure monitoring, device of claim 1, further comprising a backup power in the fire and tamper resistant enclosure.

6. The secure monitoring device of claim 1, further comprising a data storage in the fire and tamper resistant enclosure.

7. The secure monitoring device of claim 1, further comprising a communications module in the fire and tamper resistant enclosure.

8. The secure monitoring device of claim 1, further comprising preprogramming and packaging as an integrated budding security and building automation device.

9. The system of claim 1, further comprising a video analytics module to identify a person involved in the event.

10. The system of claim 1, wherein the processing device compares the event to a preprogrammed pattern, and issues an alert in response to a pattern violation.

11. A system to aid response, and investigation of events, comprising:
a secure monitoring device to receive an event;
an analysis module to analyze the event for an anomaly; and
a black-box module actuated by the analysis module when the anomaly indicates a threat to the monitoring device.

12. The system of claim 11, further comprising automatically arming the monitoring device when determining that a building is empty.

13. The system of claim 11, further comprising a communication module to issue an alert in response to a pattern violation, the alert notifying a remote administrator with information and video related to the pattern violation.

14. The system of claim 11, wherein the black-box module automatically logs information and video of the event.

15. The system of claim 11, wherein the black-box module automatically transfers information and video of the event to an off-site secure location.

16. A method of securing a monitoring device to aid response and investigation of events, comprising:
receiving an event at the monitoring device;
analyzing the event for an anomaly; and
entering a black-box mode when the anomaly indicates a threat to the monitoring device.

17. The method of claim 16, further comprising automatically arming the monitoring device when determining that a building is empty.

18. The method of claim 16, further comprising issuing an alert when analyzing the event indicates a pattern violation, the alert notifying a remote administrator with information and video of the event.

19. The method of claim 16, wherein the black-box mode automatically logs information and video of the event.

20. The method of claim 19, wherein the black-box mode automatically transfers the information and video of the event to an off-site secure location.
